(19) United States
(12) Patent Application Publication
(10) Pub. No.: US 2006/0011536 A1
(43) Pub. Date: Jan. 19, 2006

(54) Flow adjusting mechanism

(75) Inventors: Tatsuya Tashiro, Shizuoka-ken (JP); Masato Seki, Shizuoka-ken (JP); Yukio Nozaki, Shizuoka-ken (JP)

Correspondence Address: FITZPATRICK CELLA HARPER & SCINTO, 30 ROCKEFELLER PLAZA, NEW YORK, NY, 10112, US

(73) Assignee: Tokai Corporation, Tokyo (JP)

(21) Appl. No.: 10/982,775

(22) Filed: Nov. 8, 2004

(30) Foreign Application Priority Data
Jul. 15, 2004 (JP) 208173/2004
Sep. 29, 2004 (JP) 284275/2004

(51) Int. Cl. B01D 35/02

(52) U.S. Cl. 210/459; 210/503; 210/500.27

(57) ABSTRACT

A flow adjusting mechanism comprises a path, which connects a fuel tank and a gas discharging nozzle to each other, and a filter, which is located in the path. The filter has been obtained with a process, wherein an artificial leather layer, which has an open-cell microporous structure, and a micro-cellular polymer layer are laminated together, and the resulting laminate, which is composed of the artificial leather layer and the micro-cellular polymer layer, is hot-pressed such that a thickness of the laminate is reduced by 23% to 55% of an original total layer thickness of the laminate. The flow adjusting mechanism exhibits little change of a flame length with the passage of time and has a long service life.

### BACKGROUND OF THE INVENTION

1. Field of the Invention

This invention relates to a flow adjusting mechanism for use in appliances, such as gas lighters, torches, burners, and hair curlers.

2. Description of the Related Art

In appliances in which a fuel contained in a gas tank is discharged through a gas discharging nozzle and burned, such as gas lighters and burners, ordinarily, a filter is located in a path, which connects the gas tank and the gas discharging nozzle to each other, and a gas flow rate is adjusted with the filter.

By way of example, in the cases of the gas lighters, when a fire is to be lighted with a gas lighter, a pushing lever of the gas lighter is pushed down, and a nozzle is thereby pushed up against urging force of a coiled spring. As a result, an on-off valve located under the nozzle is opened. Also, a liquefied fuel contained in a fuel tank is sucked up through a sucking wick and is discharged as a vaporized fuel through the filter, the on-off valve, and the nozzle. Further, in association with the operation for pushing down the pushing lever, a lighting mechanism is actuated in order to light the vaporized fuel, which is discharged from the nozzle. In cases where the length of a flame produced is to be adjusted, a nozzle screw located on an outer peripheral side of the nozzle is rotated through a flame adjusting ring, and a nozzle bottom member, which is press-fitted into the nozzle screw and secured to the nozzle screw, is thereby moved vertically. In this manner, a degree of compression of the filter is adjusted. As a result, the flow rate of the fuel passing through the filter is adjusted, and the flame length is thus adjusted.

As a filter structure for adjusting the gas flow rate, the applicant proposed a filter having a three-layer structure. (The proposed filter having a three-layer structure is described in Japanese Utility Model Publication No. 62(1987)-5562.) The proposed filter having a three-layer structure comprises an artificial leather containing fine voids, which artificial leather has a high uniformity and a high permeability, and two urethane foam layers having a high elastic recovery, each of which urethane foam layers is laminated with one of two surfaces of the artificial leather. With the proposed filter having a three-layer structure, by the utilization of the permeable material having the fine void structure, it is possible to achieve flame adjustment, such that little variation occurs among mass-produced filters, and such that a rate of change is stable in a practical flame length range of the gas lighter. Also, since the permeable material is laminated with the urethane foam layers having a high elastic recovery, the elasticity of the entire filter is capable of being kept for a long period of time. Further, since the two urethane foam layers are located on the opposite surfaces of the filter, the assembling workability is capable of being kept high.

With the filter having a three-layer structure, which is described in Japanese Utility Model Publication No. 62(1987)-5562, the urethane foam layers having a high elastic recovery and good adhesion properties are utilized, and the artificial leather layer, which has a high uniformity and acts as a principal member for the adjustment of the permeation flow rate, is located between the urethane foam layers. Therefore, the proposed filter having a three-layer structure is capable of performing reliable flame length adjustment over a broad range.

### SUMMARY OF THE INVENTION

The primary object of the present invention is to provide a flow adjusting mechanism for adjusting a gas flow rate with a filter having a multi-layer structure, which flow adjusting mechanism exhibits little change of a flame length with the passage of time and has a long service life.

The present invention provides a flow adjusting mechanism, comprising:

i) a path, which connects a fuel tank and a gas discharging nozzle to each other, and

ii) a filter, which is located in the path,

the filter having been obtained with a process, wherein an artificial leather layer, which has an open-cell microporous structure, and a micro-cellular polymer layer are laminated together, and the resulting laminate, which is composed of the artificial leather layer and the micro-cellular polymer layer, is hot-pressed such that a thickness of the laminate is reduced by 23% to 55% of an original total layer thickness of the laminate.

The flow adjusting mechanism in accordance with the present invention may be modified such that the filter comprises the artificial leather layer and the micro-cellular polymer layer, which is located on one of two surfaces of the artificial leather layer.

Alternatively, the flow adjusting mechanism in accordance with the present invention may be modified such that the filter comprises the artificial leather layer, a first micro-cellular polymer layer, which is located on one of two surfaces of the artificial leather layer, and a second micro-cellular polymer layer, which is located on the other surface of the artificial leather layer.

In such cases, the flow adjusting mechanism in accordance with the present invention should preferably be modified such that a ratio of an original layer thickness of the first micro-cellular polymer layer before the hot pressing is performed: an original layer thickness of the artificial leather layer before the hot pressing is performed: an original layer thickness of the second micro-cellular polymer layer before the hot pressing is performed falls within the range of 0.8 to 1.2:1:0.8 to 1.2.

Also, the flow adjusting mechanism in accordance with the present invention should preferably be modified such that a ratio of a hot-pressed layer thickness of the first micro-cellular polymer layer after the hot pressing has been performed: a hot-pressed layer thickness of the artificial leather layer after the hot pressing has been performed: a hot-pressed layer thickness of the second micro-cellular polymer layer after the hot pressing has been performed is approximately 2:1:2.

Further, the flow adjusting mechanism in accordance with the present invention should preferably be modified such that a compression residual strain of the micro-cellular polymer layer falls within the range of 2.7% to 4.6%. The term “compression residual strain” as used herein means the compression residual strain as measured in accordance with JIS-K6401. Specifically, the compression residual strain is measured with a procedure, wherein the micro-cellular polymer layer is compressed by 50%, the micro-cellular polymer layer is then allowed to stand at 70° C. for 22 hours, the micro-cellular polymer layer is thereafter released from the compression, and a change of the thickness of the micro-cellular polymer layer, which change occurs 30 minutes after the micro-cellular polymer layer has been released from the compression, is measured.

Furthermore, the flow adjusting mechanism in accordance with the present invention should preferably be modified such that a density of the micro-cellular polymer layer before the hot pressing is performed falls within the range of 0.24 g/cm³ to 0.48 g/cm³. The density of the micro-cellular polymer layer is the value as measured in accordance with JIS-K6301.

Also, the flow adjusting mechanism in accordance with the present invention should preferably be modified such that the ratio of the hot-pressed layer thickness of the first micro-cellular polymer layer of the filter: the hot-pressed layer thickness of the artificial leather layer of the filter: the hot-pressed layer thickness of the second micro-cellular polymer layer of the filter, which ratio is obtained after the filter has been incorporated into the flow adjusting mechanism and has been mechanically compressed within the flow adjusting mechanism, is approximately 1.5:1:1.5.

The flow adjusting mechanism in accordance with the present invention comprises the path, which connects the fuel tank and the gas discharging nozzle to each other, and the filter, which is located in the path. The filter has been obtained with the process, wherein the artificial leather layer, which has the open-cell microporous structure, and the micro-cellular polymer layer are laminated together, and the resulting laminate, which is composed of the artificial leather layer and the micro-cellular polymer layer, is hot-pressed such that the thickness of the laminate is reduced by 23% to 55% of the original total layer thickness of the laminate. Therefore, with the flow adjusting mechanism in accordance with the present invention, little deterioration occurs with the filter with the passage of time. Also, the change of the flame length with the passage of time is capable of being kept small. Therefore, a service life of appliances, such as gas lighters, in which the flow adjusting mechanism in accordance with the present invention is located in a valve mechanism, is capable of being kept long.

### BRIEF DESCRIPTION OF THE DRAWINGS

FIG. 1A is an enlarged sectional view showing part of an example of a filter laminate before being subjected to hot pressing,

FIG. 1B is an enlarged sectional view showing part of a different example of a filter laminate before being subjected to hot pressing,

FIG. 2A is an enlarged sectional view showing part of the example of the filter laminate before being subjected to the hot pressing,

FIG. 2B is an enlarged sectional view showing part of a filter obtained from the hot pressing of the filter laminate shown in FIG. 2A,

FIG. 3 is a sectional view showing a valve mechanism of a gas lighter, in which an embodiment of the flow adjusting mechanism in accordance with the present invention is employed,

FIG. 4 is a graph showing relationship between a hot pressing rate and a flame length, which relationship is obtained with a filter having a three-layer structure in cases where an original thickness of each of two micro-cellular polymer layers before hot pressing is performed is 0.5 mm,

FIG. 5 is a graph showing relationship between a hot pressing rate and a flame length, which relationship is obtained with a filter having a three-layer structure in cases where an original thickness of each of two micro-cellular polymer layers before hot pressing is performed is 0.8 mm,

FIG. 6 is a graph showing relationship between a hot pressing rate and a flame length, which relationship is obtained with a filter having a three-layer structure in cases where an original thickness of each of two micro-cellular polymer layers before hot pressing is performed is 1 mm,

FIG. 7 is a graph showing relationship between a hot pressing rate and a flame length, which relationship is obtained with a filter having a three-layer structure in cases where an original thickness of each of two micro-cellular polymer layers before hot pressing is performed is 1.2 mm,

FIG. 8 is a graph showing relationship between a hot pressing rate and a flame length, which relationship is obtained with a filter having a three-layer structure in cases where an original thickness of each of two micro-cellular polymer layers before hot pressing is performed is 1.5 mm,

FIG. 9 is a table showing hot-pressed layer thicknesses of an upper micro-cellular polymer layer I, an artificial leather layer, and a lower micro-cellular polymer layer I constituting a filter having a three-layer structure and having been obtained after a filter laminate having a three-layer structure, in which a ratio of an original layer thickness of the upper micro-cellular polymer layer I: an original layer thickness of the artificial leather layer : an original layer thickness of the lower micro-cellular polymer layer I is 1:1:1, has been hot-pressed to a thickness of 1.9 mm,

FIG. 10 is a table showing hot-pressed layer thicknesses of an upper micro-cellular polymer layer II, an artificial leather layer, and a lower micro-cellular polymer layer II constituting a filter having a three-layer structure and having been obtained after a filter laminate having a three-layer structure, in which a ratio of an original layer thickness of the upper micro-cellular polymer layer II: an original layer thickness of the artificial leather layer: an original layer thickness of the lower micro-cellular polymer layer II is 1:1:1, has been hot-pressed to a thickness of 1.9 mm,

FIG. 11 is a table showing the hot-pressed layer thicknesses of the upper micro-cellular polymer layer I, the artificial leather layer, and the lower micro-cellular polymer layer I constituting the filter, which thicknesses are obtained after the filter has been incorporated into a flow adjusting mechanism and has been mechanically compressed within the flow adjusting mechanism,

FIG. 12 is a table showing the hot-pressed layer thicknesses of the upper micro-cellular polymer layer II, the artificial leather layer, and the lower micro-cellular polymer layer II constituting the filter, which thicknesses are obtained after the filter has been incorporated into a flow adjusting mechanism and has been mechanically compressed within the flow adjusting mechanism, and

FIGS. 13A, 13B, and 13C are graphs showing changes of a flame length variable width with the passage of time, which have been obtained with a filter employed in the flow adjusting mechanism in accordance with the present invention.

### DESCRIPTION OF THE PREFERRED EMBODIMENTS

The present invention will here in below be described in further detail with reference to the accompanying drawings.

The flow adjusting mechanism in accordance with the present invention is provided with the filter having been obtained with the process, wherein the artificial leather layer, which has the open-cell microporous structure, and the micro-cellular polymer layer are laminated together, and the resulting laminate, which is composed of the artificial leather layer and the micro-cellular polymer layer, is hot-pressed such that the thickness of the laminate is reduced by 23% to 55% of the original total layer thickness of the laminate.

The micro-cellular polymer layer of the filter employed in the flow adjusting mechanism in accordance with the present invention may be constituted of a material, such as an ether type of polyurethane or an ester type of polyurethane. The compression residual strain of the micro-cellular polymer layer should preferably fall within the range of 2.7% to 4.6%. If the compression residual strain of the micro-cellular polymer layer is smaller than 2.7%, it will become difficult for the hot pressing to be performed. If the compression residual strain of the micro-cellular polymer layer is larger than 4.6%, repulsion force of the micro-cellular polymer layer after the hot pressing has been performed will not be capable of being obtained.

Also, the density of the micro-cellular polymer layer before the hot pressing is performed should preferably fall within the range of 0.24 g/cm³ to 0.48 g/cm³. If the density of the micro-cellular polymer layer before the hot pressing is performed is lower than 0.24 g/cm³, the variable width of the flame length after the hot pressing has been performed will become large. If the density of the micro-cellular polymer layer before the hot pressing is performed is higher than 0.48 g/cm³, the micro-cellular polymer layer will become hard, and it will become difficult for the hot pressing to be performed.

Specifically, the micro-cellular polymer layer should preferably be constituted of an ether type of urethane, which is a high-density micro-cellular polymer and contains cells having a cell diameter falling within the range of 10 μm to 300 μm. The micro-cellular polymer layer may be produced with a technique described in, for example, Japanese Patent No. 938508 (corresponding to Japanese Patent Publication No. 53(1978)-8735).

The artificial leather layer should preferably be constituted of an artificial leather comprising a polyester fiber, which has an open-cell microporous structure, and a polyurethane elastomer, which is impregnated in the polyester fiber.

Both the micro-cellular polymer layer and the artificial leather layer described above contain the urethane constituents. Therefore, the micro-cellular polymer layer and the artificial leather layer are capable of being easily adhered together by use of, for example, a process, in which the micro-cellular polymer layer and the artificial leather layer are superposed one upon the other and subjected to the hot pressing. Specifically, firstly, the micro-cellular polymer layer may be superposed upon one of two surfaces of the artificial leather layer, and the two-layer laminate may thus be formed. Alternatively, two micro-cellular polymer layers may be superposed upon the opposite surfaces of the artificial leather layer, and the three-layer laminate may thus be formed. Thereafter, the thus formed laminate may be cut into a desired size. The thus cut piece may then be subjected to the hot pressing and may thus be compressed in the thickness direction. With the hot pressing, the micro-cellular polymer layer (or the two micro-cellular polymer layers) and the artificial leather layer are adhered together through thermal fusion. In such cases, the hot pressing is performed such that the thickness of the laminate, which is composed of the artificial leather layer (or the two micro-cellular polymer layers) and the micro-cellular polymer layer, is reduced by 23% to 55% of the original total layer thickness of the laminate.

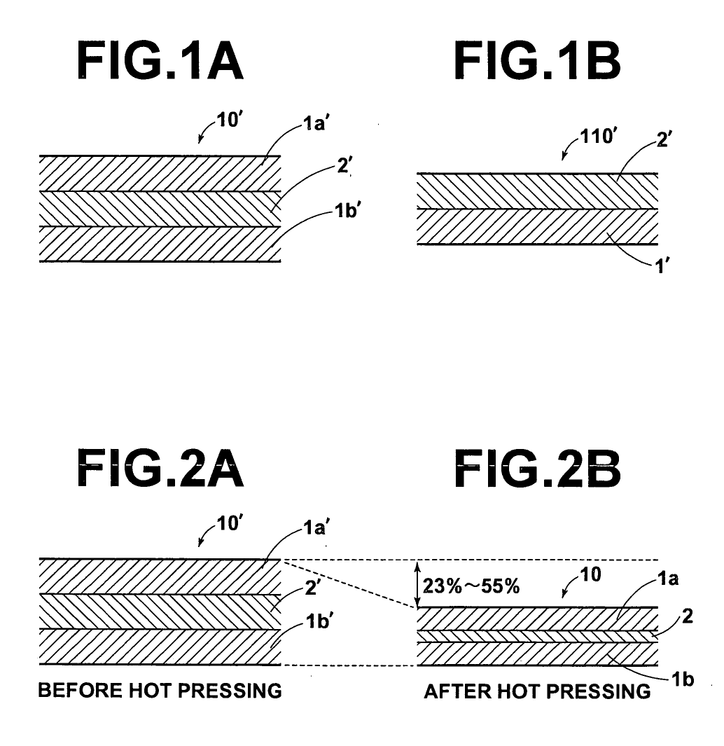

The filter incorporated in the flow adjusting mechanism in accordance with the present invention will be described hereinbelow with reference to the accompanying drawings. FIG. 1A is an enlarged sectional view showing part of an example of a filter laminate before being subjected to hot pressing. FIG. 1B is an enlarged sectional view showing part of a different example of a filter laminate before being subjected to hot pressing. As illustrated in FIG. 1A, a filter laminate 10′ has a three-layer structure. The filter laminate 10′ comprises an artificial leather layer 2′, an upper micro-cellular polymer layer 1a′, and a lower micro-cellular polymer layer 1b′, each of which micro-cellular polymer layers is located on one of the two surfaces of the artificial leather layer 2′. Alternatively, the filter incorporated in the flow adjusting mechanism in accordance with the present invention maybe obtained from a filter laminate 110′ illustrated in FIG. 1B. The filter laminate 110′ illustrated in FIG. 1B has a two-layer structure comprising a micro-cellular polymer layer 1′ and the artificial leather layer 2′, which are superposed one upon the other. By way of example, the flow adjusting mechanism in accordance with the present invention, in which the filter having the three-layer structure is employed, will be described hereinbelow.

FIG. 2A is an enlarged sectional view showing part of the example of the filter laminate before being subjected to the hot pressing. FIG. 2B is an enlarged sectional view showing part of a filter obtained from the hot pressing of the filter laminate shown in FIG. 2A. By way of example, as illustrated in FIG. 2A, the filter laminate 10′ may have the three-layer structure (having a total layer thickness of 3 mm) comprising the artificial leather layer 2′ having a thickness of 1 mm, the upper micro-cellular polymer layer 1a′ having a thickness of 1 mm, and the lower micro-cellular polymer layer 1b′ having a thickness of 1 mm, each of which micro-cellular polymer layers is located on one of the two surfaces of the artificial leather layer 2′. In such cases, the filter laminate 10′ having the thickness of 3 mm is hot-pressed to a thickness falling within the range of 2.31 mm (in the cases of the hot pressing by 23%) to 1.35 mm (in the cases of the hot pressing by 55%). With the hot pressing, as illustrated in FIG. 2B, a hot-pressed filter sheet 10 comprising an artificial leather layer 2, an upper micro-cellular polymer layer 1a, and a lower micro-cellular polymer layer 1b is obtained. The thus obtained hot-pressed filter sheet 10 is then subjected to cutting and punching, and a filter is thereby formed. The thus obtained filter will also be referred to as the filter 10. The thus obtained filter 10 is then incorporated into a valve mechanism of a gas lighter or other appliances.

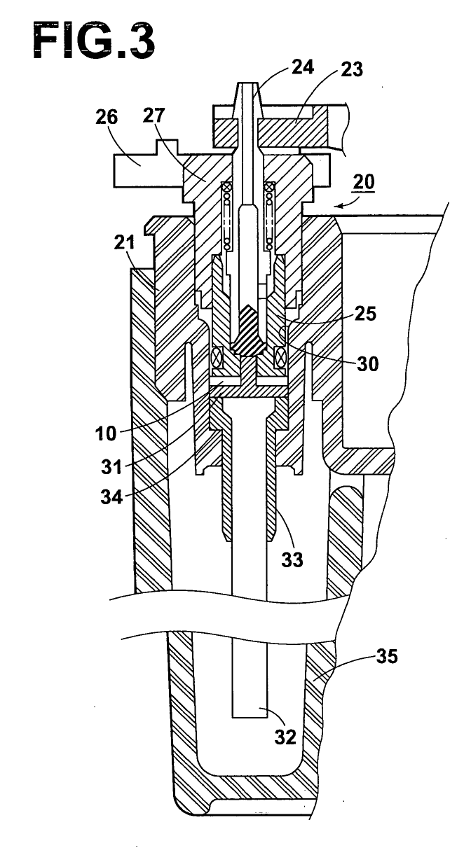

FIG. 3 is a sectional view showing a valve mechanism of a gas lighter, in which an embodiment of the flow adjusting mechanism in accordance with the present invention provided with the filter 10 having the three-layer structure having been formed in the manner described above is employed. With reference to FIG. 3, a valve mechanism 20 is fitted into a tank top cover member 21. The valve mechanism 20 comprises a nozzle 24 for turning on and off the gas discharging. A lever 23 is engaged with the nozzle 24. The valve mechanism 20 also comprises a nozzle screw 27 for supporting the nozzle 24. A nozzle bottom member 25 for adjusting a pressure, which is applied to the filter 10 having the three-layer structure, is inserted into the nozzle screw 27. Also, a flame length adjusting ring 26 is engaged with the nozzle screw 27. The valve mechanism 20 further comprises the filter 10 having the three-layer structure for adjusting the gas flow rate.

The valve mechanism 20 is engaged by threads with a cylindrical hole section 30 of the tank top cover member 21. The tank top cover member 21 is secured to a tank 35 for storing a gas therein. The nozzle 24 has a cylindrical shape. The nozzle 24 comprises a through-hole, which extends through the center region of the nozzle 24 and along the axial direction of the nozzle 24. The nozzle 24 also comprises a lateral hole, which communicates with the through-hole. The nozzle 24 further comprises a hemispherical rubber valve seat, which is secured to a bottom section so as to close the through-hole. The nozzle 24 still further comprises a spring receiver, which is protruded at an approximately middle region of the outer periphery of the nozzle 24. The nozzle 24 is fitted into the tank top cover member 21 via the nozzle screw 27.

The nozzle screw 27 is constituted of a tube-like member having an open bottom. The nozzle screw 27 has teeth, which are formed over the entire outer periphery of a top region of the nozzle screw 27. The flame length adjusting ring 26 has teeth, which correspond to the teeth of the nozzle screw 27 and are formed at the inner periphery of the flame length adjusting ring 26. The teeth of the flame length adjusting ring 26 are engaged with the teeth of the nozzle screw 27. Also, the nozzle bottom member 25, which is made from a metal, is fitted into the open bottom region of the nozzle screw 27. The nozzle bottom member 25 has a smooth bottom surface and has a through-hole, which extends through the center region of the nozzle bottom member 25 and along the axial direction of the nozzle bottom member 25. The nozzle 24 is loosely fitted and located in the interior of the nozzle bottom member 25, such that the valve seat of the nozzle 24 stands facing down. Further, an external thread, which is formed on the outer periphery of the nozzle screw 27, is engaged with an internal thread, which is formed on the inner periphery of the cylindrical hole section 30 of the tank top cover member 21.

The filter 10 having the three-layer structure is located on a nail-shaped stator 31 constituting a filter support member, such that the filter 10 having the three-layer structure may be in contact with the smooth surface at the bottom end of the nozzle bottom member 25. A wick 32 and a wick holder 33 are located such that they are in contact with a bottom end surface of the nail-shaped stator 31, which acts to give heat for the vaporization of the liquefied gas. The wick 32 passes through the cylindrical hole section 30 of the tank top cover member 21 and extends in the tank 35. The wick holder 33 is made from a metal and supports the wick 32. The wick holder 33 has a flange, which is formed at a top region of the wick holder 33. The flange of the wick holder 33 is brought into contact with a flange section 34 of the tank top cover member 21 and is thus supported by the flange section 34.

In cases where the gas lighter is to be used, a lighting member (not shown) is actuated, while the lever 23 is being pushed up. In this manner, the gas having been jetted out from the nozzle 24 is lighted. At this time, the gas, which is jetted out from the nozzle 24, is formed from the liquefied gas sucked up through the wick 32, which extends in the tank 35. The liquefied gas having thus been sucked up is vaporized with heat given by the wick holder 33 and the nail-shaped stator 31, while the liquefied gas is moving from the bottom surface of the nail-shaped stator 31 to the peripheral wall. Also, the flow rate of the gas is adjusted by the filter 10 having the three-layer structure, and the gas is jetted out through a space formed between the nozzle bottom member 25 and the valve seat, which is pulled up against urging force of a spring.

In cases where the flame length adjusting ring 26 is rotated in a negative direction, the nozzle screw 27 is rotated, such that the nozzle bottom member 25 is pushed down toward the nail-shaped stator 31. In this manner, the filter 10 having the three-layer structure is compressed. As a result, the gas flow rate in the filter 10 having the three-layer structure is restricted, and the flame is-capable of being rendered small. In cases where the flame length adjusting ring 26 is rotated in a positive direction, the nozzle screw 27 is slightly moved up from the tank top cover member 21, and the nozzle bottom member 25 is pulled up. As a result, the compressing force, which is given from the nozzle bottom member 25 to the filter 10 having the three-layer structure, becomes weak. In this manner, the gas flow rate in the filter 10 having the three-layer structure becomes high, and the flame is capable of being rendered large.

In the embodiment described above, the flow adjusting mechanism in accordance with the present invention is utilized in the gas lighter. However, the flow adjusting mechanism in accordance with the present invention is not limited to the use in the gas lighter and may be utilized in various appliances, such as torches, burners, and hair curlers, in which a fuel is discharged from a tank through a nozzle and burned.

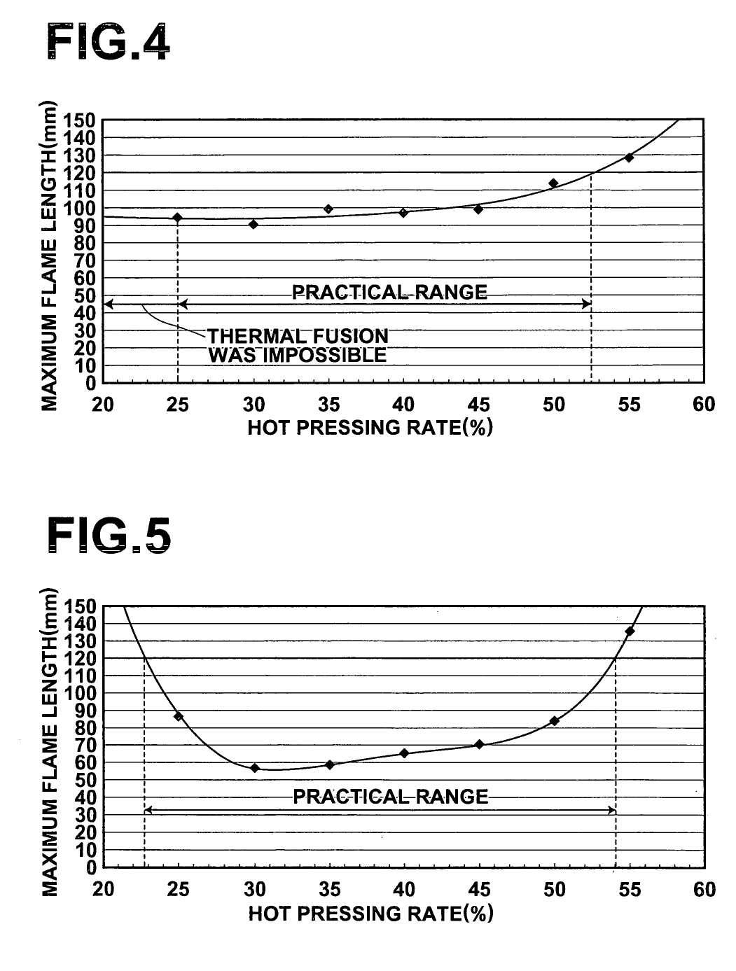

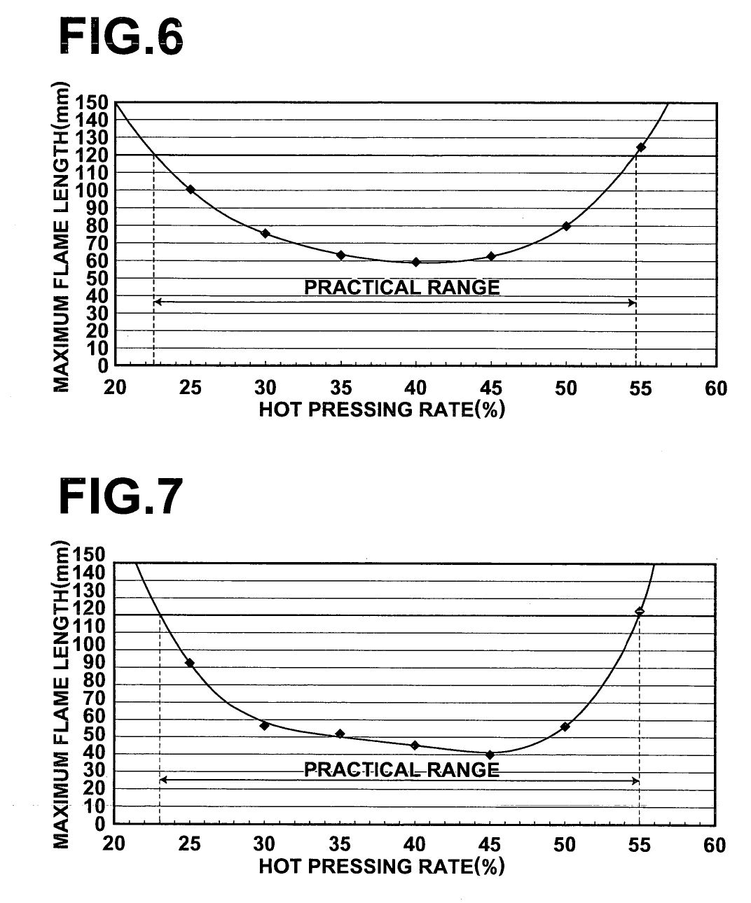

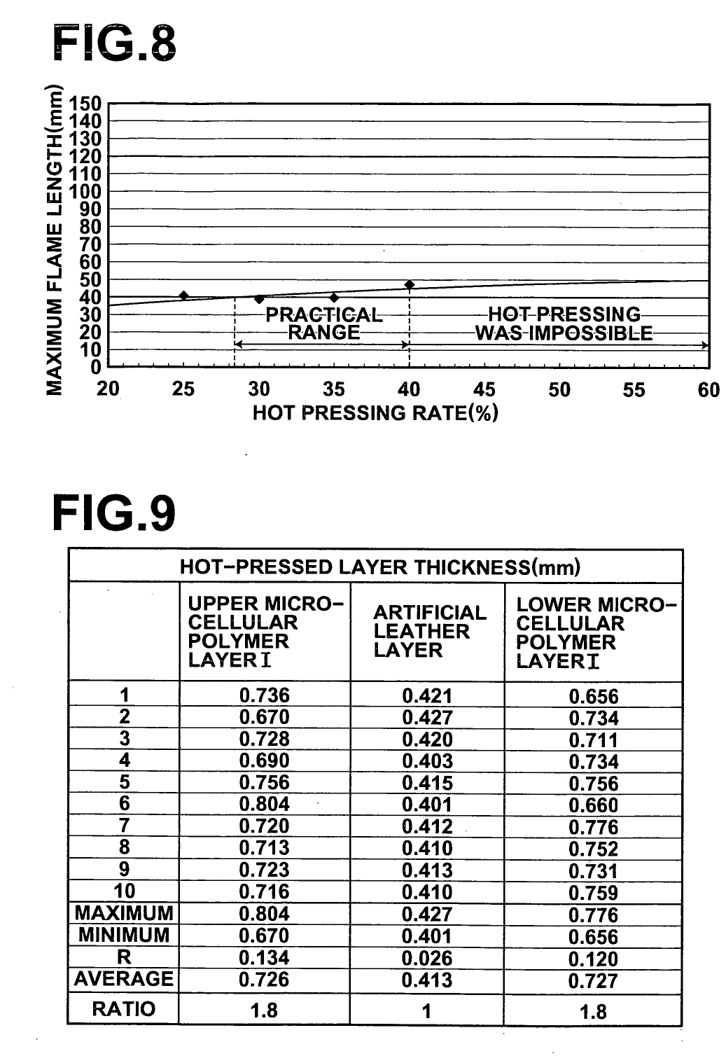

Relationship between a hot pressing rate and a flame length, which relationship is obtained with a filter having a three-layer structure incorporated in the gas lighter having the valve mechanism illustrated in FIG. 3, will be described hereinbelow with reference to each of FIG. 4 to FIG. 8. FIG. 4 is a graph showing relationship between a hot pressing rate and a flame length, which relationship is obtained with a filter having a three-layer structure in cases where an original thickness of an artificial leather layer before hot pressing is performed is 1 mm, and an original thickness of each of two micro-cellular polymer layers before hot pressing is performed is 0.5 mm. FIG. 5 is a graph showing relationship between a hot pressing rate and a flame length, which relationship is obtained with a filter having a three-layer structure in cases where an original thickness of an artificial leather layer before hot pressing is performed is 1 mm, and an original thickness of each of two micro-cellular polymer layers before hot pressing is performed is 0.8 mm. FIG. 6 is a graph showing relationship between a hot pressing rate and a flame length, which relationship is obtained with a filter having a three-layer structure in cases where an original thickness of an artificial leather layer before hot pressing is performed is 1 mm, and an original thickness of each of two micro-cellular polymer layers before hot pressing is performed is 1 mm. FIG. 7 is a graph showing relationship between a hot pressing rate and a flame length, which relationship is obtained with a filter having a three-layer structure in cases where an original thickness of an artificial leather layer before hot pressing is performed is 1 mm, and an original thickness of each of two micro-cellular polymer layers before hot pressing is performed is 1.2 mm. FIG. 8 is a graph showing relationship between a hot pressing rate and a flame length, which relationship is obtained with a filter having a three-layer structure in cases where an original thickness of an artificial leather layer before hot pressing is performed is 1 mm, and an original thickness of each of two micro-cellular polymer layers before hot pressing is performed is 1.5 mm.

Flame length tests were conducted in the manner described below. Specifically, with respect to each of the filters having the thicknesses described above, the hot pressing rate was set at 25% hot pressing, 30% hot pressing, 35% hot pressing, 40% hot pressing, 45% hot pressing, 50% hot pressing, and 55% hot pressing. The filter obtained with each of the hot pressing rates described above was incorporated in the valve mechanism of the gas lighter illustrated in FIG. 3. Also, adjustment was made such that the flame length became equal to 30 mm in a state in which the flame length adjusting ring 26 was set at a middle position. Further, tests were performed in order to find how the maximum flame length changed in accordance with the alteration of the hot pressing rate. In the cases of gas lighters, the maximum flame length, which is ordinarily allowed, is approximately 120 mm. Therefore, the filters having the three-layer structures were evaluated with the maximum flame length equal to at most approximately 120 mm being taken as the practical flame length range.

In the cases of the filter having the three-layer structure used in the flame length test of FIG. 4, the ratio of the original layer thickness of the upper micro-cellular polymer layer before the hot pressing was performed: the original layer thickness of the artificial leather layer before the hot pressing was performed: the original layer thickness of the lower micro-cellular polymer layer before the hot pressing was performed was 0.5:1:0.5. In such cases, the maximum flame length did not become small when the hot pressing rate was set to be low. This is presumably because the proportion of the micro-cellular polymer layers occupying in the filter having the three-layer structure is small, and the variable width of the permeability to the fuel gas is small between the cases wherein the hot pressing rate is set to be low and the cases wherein the hot pressing rate is set to be high. In cases where the hot pressing rate was set to be lower than 25%, the thermal fusion of the micro-cellular polymer layers and the artificial leather layer to each other became difficult. Therefore, in this case, the practical range of the hot pressing rate was from 25% to approximately 53%.

In the cases of the filter having the three-layer structure used in the flame length test of FIG. 5, the ratio of the original layer thickness of the upper micro-cellular polymer layer before the hot pressing was performed: the original layer thickness of the artificial leather layer before the hot pressing was performed: the original layer thickness of the lower micro-cellular polymer layer before the hot pressing was performed was 0.8:1:0.8. In this test, when the hot pressing rate was set to be low, the permeability of the micro-cellular polymer layers to the fuel gas became high, and the flame length became long. Also, when the hot pressing rate was set to be high, closed cells contained in the micro-cellular polymer layers were broken in to open cells. As a result, the permeability to the fuel gas became high, and the flame length became long. In this case, the practical range of the hot pressing rate was from approximately 23% to approximately 54%.

In the cases of the filter having the three-layer structure used in the flame length test of FIG. 6, the ratio of the original layer thickness of the upper micro-cellular polymer layer before the hot pressing was performed: the original layer thickness of the artificial leather layer before the hot pressing was performed: the original layer thickness of the lower micro-cellular polymer layer before the hot pressing was performed was 1:1:1. In this case, the practical range of the hot pressing rate was from 22.5% to 55%.

In the cases of the filter having the three-layer structure used in the flame length test of FIG. 7, the ratio of the original layer thickness of the upper micro-cellular polymer layer before the hot pressing was performed: the original layer thickness of the artificial leather layer before the hot pressing was performed: the original layer thickness of the lower micro-cellular polymer layer before the hot pressing was performed was 1.2:1:1.2. In this case, the practical range of the hot pressing rate was from 23% to 55%.

In the cases of the filter having the three-layer structure used in the flame length test of FIG. 8, the ratio of the original layer thickness of the upper micro-cellular polymer layer before the hot pressing was performed: the original layer thickness of the artificial leather layer before the hot pressing was performed: the original layer thickness of the lower micro-cellular polymer layer before the hot pressing was performed was 1.5:1:1.5. In such cases, the maximum flame length was as short as approximately 40 mm, which was required as the maximum flame length with the gas lighters. This is presumably because the proportion of the micro-cellular polymer layers occupying in the filter having the three-layer structure is large, and the permeability to the fuel gas is not apt to change when the thickness of the filter is altered mechanically at the time of the incorporation of the filter into the lighter. In this test, since the proportion of the micro-cellular polymer layers occupying in the filter having the three-layer structure was large, the hot pressing was not capable of being effected with a hot pressing rate of 50% or more. Therefore, in this case, the practical range of the hot pressing rate was from approximately 28% to approximately 40%.

From the results of the flame length tests described above, it is capable of being found that the efficient filter hot pressing rate falls within the range of approximately 23% to approximately 55%, and that the ratio of the original layer thickness of the upper micro-cellular polymer layer before the hot pressing is performed: the original layer thickness of the artificial leather layer before the hot pressing is performed: the original layer thickness of the lower micro-cellular polymer layer before the hot pressing is performed should preferably fall within the range of 0.8˜1.2: 1:0.8˜1.2.

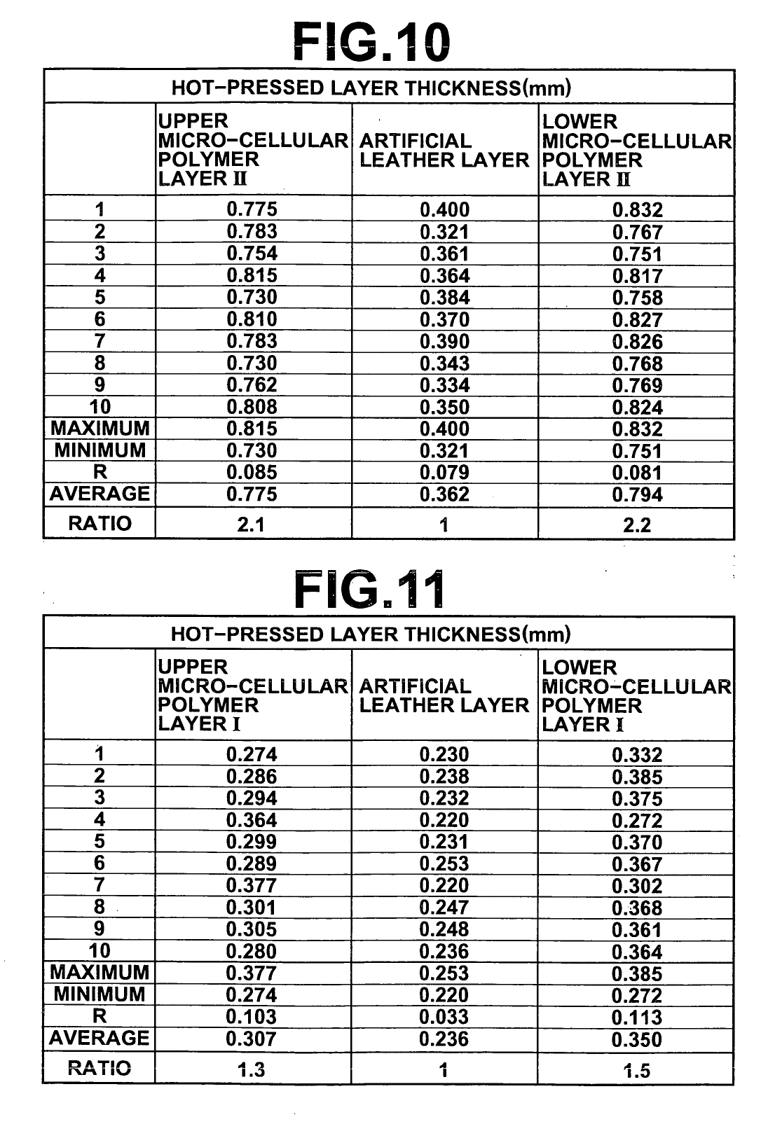

FIG. 9 is a table showing hot-pressed layer thicknesses of an upper micro-cellular polymer layer I, an artificial leather layer, and a lower micro-cellular polymer layer I constituting a filter having a three-layer structure and having been obtained after a filter laminate having a three-layer structure, in which a ratio of an original layer thickness of the upper micro-cellular polymer layer I: an original layer thickness of the artificial leather layer: an original layer thickness of the lower micro-cellular polymer layer I is 1:1:1, has been hot-pressed to a thickness of 1.9 mm. FIG. 10 is a table showing hot-pressed layer thicknesses of an upper micro-cellular polymer layer II, an artificial leather layer, and a lower micro-cellular polymer layer II constituting a filter having a three-layer structure and having been obtained after a filter laminate having a three-layer structure, in which a ratio of an original layer thickness of the upper micro-cellular polymer layer II: an original layer thickness of the artificial leather layer: an original layer thickness of the lower micro-cellular polymer layer II is 1:1:1, has been hot-pressed to a thickness of 1.9 mm. The micro-cellular polymer layer I and the micro-cellular polymer layer II are of different kinds. FIG. 9 shows the results of the measurements made for ten samples. Also, FIG. 10 shows the results of the measurements made for ten samples. As clear from FIG. 9 and FIG. 10, the ratio of the hot-pressed layer thickness of the upper micro-cellular polymer layer after the hot pressing has been performed: the hot-pressed layer thickness of the artificial leather layer after the hot pressing has been performed: the hot-pressed layer thickness of the lower micro-cellular polymer layer after the hot pressing has been performed was approximately 2:1:2.

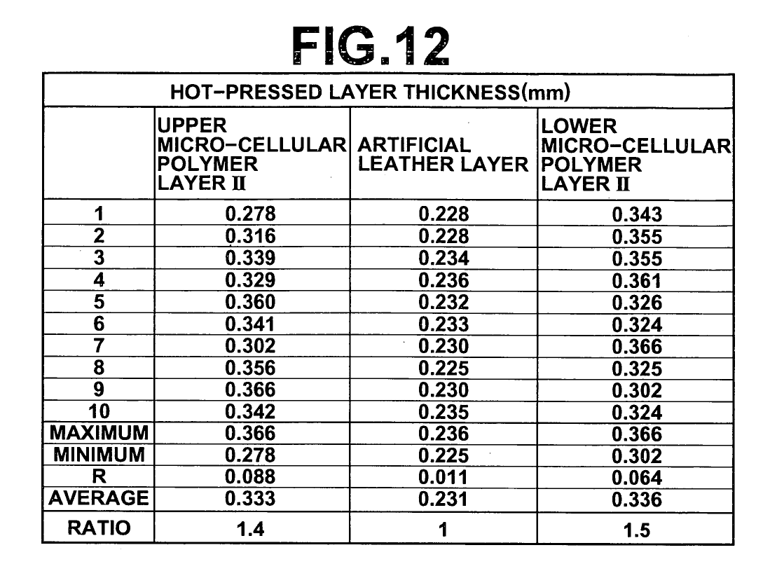

FIG. 11 is a table showing the hot-pressed layer thicknesses of the upper micro-cellular polymer layer I, the artificial leather layer, and the lower micro-cellular polymer layer I constituting the filter, which thicknesses are obtained after the filter has been incorporated into a flow adjusting mechanism and has been mechanically compressed within the flow adjusting mechanism. FIG. 12 is a table showing the hot-pressed layer thicknesses of the upper micro-cellular polymer layer II, the artificial leather layer, and the lower micro-cellular polymer layer II constituting the filter, which thicknesses are obtained after the filter has been incorporated into a flow adjusting mechanism and has been mechanically compressed within the flow adjusting mechanism. FIG. 11 and FIG. 12 show the results of measurements made in the manner described below. Specifically, each of the hot-pressed filters illustrated in FIG. 9 and FIG. 10 was incorporated into the valve mechanism of the gas lighter having the valve mechanism illustrated in FIG. 3. Also, the flame length adjusting ring 26 was rotated in the negative direction, and the nozzle screw 27 was thus rotated. The nozzle bottom member 25 was thus pushed down toward the nail-shaped stator 31. In this manner, the filter having the three-layer structure was compressed mechanically. Also, adjustment was made such that the flame length became equal to 30 mm in a state in which the flame length adjusting ring 26 was set at the middle position. In this state, the hot-pressed layer thicknesses were measured for ten samples. As clear from each of FIG. 11 and FIG. 12, the ratio of the hot-pressed layer thickness of the upper micro-cellular polymer layer of the filter: the hot-pressed layer thickness of the artificial leather layer of the filter: the hot-pressed layer thickness of the lower micro-cellular polymer layer of the filter, which ratio was obtained after the filter had been incorporated into the flow adjusting mechanism and had been mechanically compressed within the flow adjusting mechanism, was approximately 1.5:1:1.5.

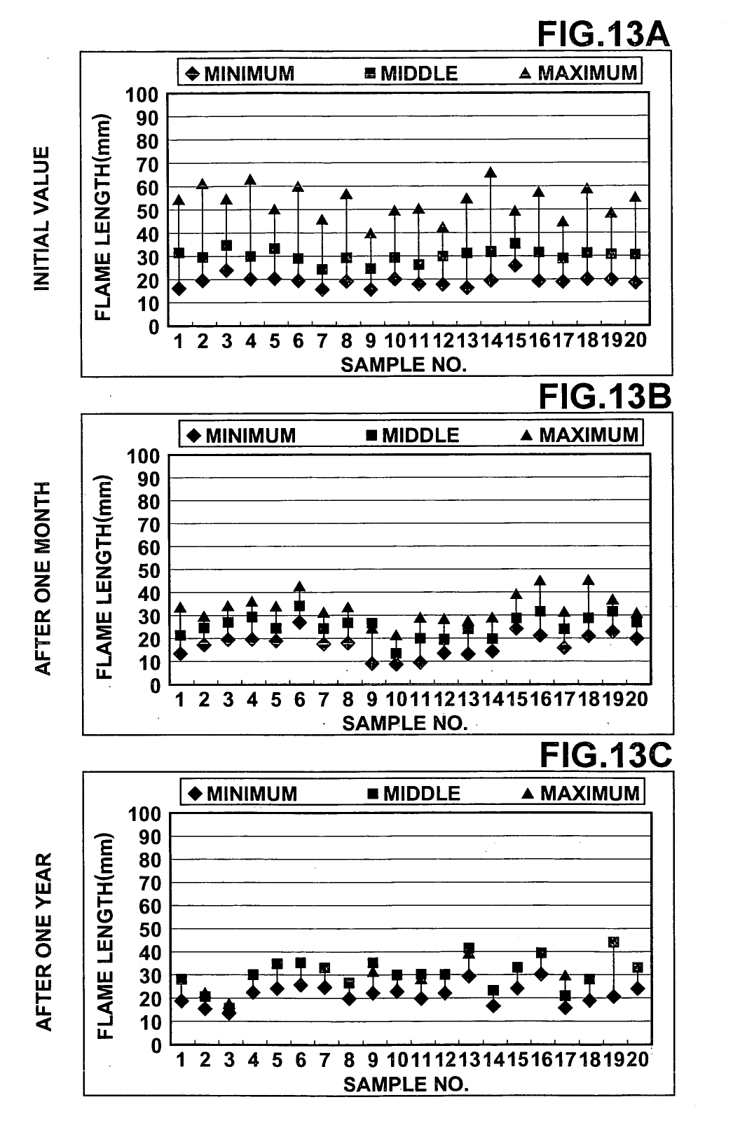

FIGS. 13A, 13B, and 13C are graphs showing changes of a flame length variable width with the passage of time, which have been obtained with a filter employed in the flow adjusting mechanism in accordance with the present invention. A filter having a three-layer structure (having an original total layer thickness of 3 mm) comprising an artificial leather layer, which had an original thickness of 1 mm, and two micro-cellular polymer layers, each of which had an original thickness of 1 mm and was located on one of the two surfaces of the artificial leather layer, was prepared. The prepared filter having the original total layer thickness of 3 mm was then hot-pressed to a hot-pressed thickness of 1.9 mm (hot pressing rate: 37%). The thus obtained filter was used as the filter of the flow adjusting mechanism.

The changes of the flame length variable width with the passage of time were measured in the manner described below. Specifically, each of 20 samples of the filter described above was incorporated in one of valve mechanisms of 20 gas lighters having the valve mechanism illustrated in FIG. 3. Also, adjustment was made such that the flame length became equal to 30 mm in a state in which the flame length adjusting ring was set at a middle position. Thereafter, each filter sample was allowed to stand at an ambient temperature of 50° C. in a state, in which the flame length adjusting ring was set at the position for the minimum flame length, i.e. in which the filter sample was being tightened. Also, how the flame length changed with the passage of time was measured at each of an initial stage, a stage after one month, and a stage after one year. At each of the stages, the gas lighter was stabilized at an ambient temperature of 23±2° C., and thereafter the measurement of the flame length was made. In each of FIGS. 13A, 13B, and 13C, the “♦” mark represents the flame length obtained in cases where the flame length adjusting ring was set at the position for the minimum flame length. Also, the “ [symbol] ” mark represents the flame length obtained in cases where the flame length adjusting ring was set at the middle position. Further, the “▴” mark represents the flame length obtained in cases where the flame length adjusting ring was set at the position for the maximum flame length.

From the results of the measurement illustrated in FIGS. 13A, 13B, and 13C, it was found that, with the filter employed in the flow adjusting mechanism in accordance with the present invention, the fluctuation of the variable width of the flame length after the filter was allowed to stand for one month was small, and the flame length did not became longer than the maximum flame length of 120 mm, which is ordinarily allowed for the gas lighters. Also, after the filter employed in the flow adjusting mechanism in accordance with the present invention was allowed to stand for one year, though the variable width of the flame length became comparatively small, practical problems were not encountered.

As described above, with the flow adjusting mechanism in accordance with the present invention, the filter employed in the flow adjusting mechanism has been obtained with a process, wherein the laminate, which is composed of the artificial leather layer and the micro-cellular polymer layer, is hot-pressed such that the thickness of the laminate is reduced by 23% to 55% of the original total layer thickness of the laminate. Therefore, with the flow adjusting mechanism in accordance with the present invention, the filter is free from deterioration with the passage of time, and the change of the flame length with the passage of time is capable of being kept small. Accordingly, the service life of appliances, such as gas lighters, in which the flow adjusting mechanism in accordance with the present invention is located in the valve mechanism, is capable of being kept long.

What is claimed is:

1. A flow adjusting mechanism, comprising:
i) a path, which connects a fuel tank and a gas discharging nozzle to each other, and
ii) a filter, which is located in the path,
the filter having been obtained with a process, wherein an artificial leather layer, which has an open-cell microporous structure, and a micro-cellular polymer layer are laminated together, and the resulting laminate, which is composed of the artificial leather layer and the micro-cellular polymer layer, is hot-pressed such that a thickness of the laminate is reduced by 23% to 55% of an original total layer thickness of the laminate.

2. A flow adjusting mechanism as defined in claim 1 wherein the filter comprises the artificial leather layer and the micro-cellular polymer layer, which is located on one of two surfaces of the artificial leather layer.

3. A flow adjusting mechanism as defined in claim 1 wherein the filter comprises the artificial leather layer, a first micro-cellular polymer layer, which is located on one of two surfaces of the artificial leather layer, and a second micro-cellular polymer layer, which is located on the other surface of the artificial leather layer.

4. A flow adjusting mechanism as defined in claim 3 wherein a ratio of an original layer thickness of the first micro-cellular polymer layer before the hot pressing is performed: an original layer thickness of the artificial leather layer before the hot pressing is performed: an original layer thickness of the second micro-cellular polymer-layer before the hot pressing is performed falls within the range of 0.8 to 1.2:1:0.8 to 1.2.

5. A flow adjusting mechanism as defined in claim 4 wherein a ratio of a hot-pressed layer thickness of the first micro-cellular polymer layer after the hot pressing has been performed: a hot-pressed layer thickness of the artificial leather layer after the hot pressing has been performed: a hot-pressed layer thickness of the second micro-cellular polymer layer after the hot pressing has been performed is approximately 2:1:2.

6. A flow adjusting mechanism as defined in claim 1 wherein a compression residual strain of the micro-cellular polymer layer falls within the range of 2.7% to 4.6%.

7. A flow adjusting mechanism as defined in claim 2 wherein a compression residual strain of the micro-cellular polymer layer falls within the range of 2.7% to 4.6%.

8. A flow adjusting mechanism as defined in claim 3 wherein a compression residual strain of each of the micro-cellular polymer layers falls within the range of 2.7% to 4.6%.

9. A flow adjusting mechanism as defined in claim 4 wherein a compression residual strain of each of the micro-cellular polymer layers falls within the range of 2.7% to 4.6%.

10. A flow adjusting mechanism as defined in claim 5 wherein a compression residual strain of each of the micro-cellular polymer layers falls within the range of 2.7% to 4.6%.

11. A flow adjusting mechanism as defined in claim 1 wherein a density of the micro-cellular polymer layer before the hot pressing is performed falls within the range of 0.24 g/cm³ to 0.48 g/cm³.

12. A flow adjusting mechanism as defined in claim 2 wherein a density of the micro-cellular polymer layer before the hot pressing is performed falls within the range of 0.24 g/cm³ to 0.48 g/cm³.

13. A flow adjusting mechanism as defined in claim 3 wherein a density of the micro-cellular polymer layer before the hot pressing is performed falls within the range of 0.24 g/cm³ to 0.48 g/cm³.

14. A flow adjusting mechanism as defined in claim 4 wherein a density of the micro-cellular polymer layer before the hot pressing is performed falls within the range of 0.24 g/cm³ to 0.48 g/cm³.

15. A flow adjusting mechanism as defined in claim 5 wherein a density of the micro-cellular polymer layer before the hot pressing is performed falls within the range of 0.24 g/cm³ to 0.48 g/cm³.

16. A flow adjusting mechanism as defined in claim 6 wherein a density of the micro-cellular polymer layer before the hot pressing is performed falls within the range of 0.24 g/cm³ to 0.48 g/cm³.

17. A flow adjusting mechanism as defined in claim 7 wherein a density of the micro-cellular polymer layer before the hot pressing is performed falls within the range of 0.24 g/cm³ to 0.48 g/cm³.

18. A flow adjusting mechanism as defined in claim 8 wherein a density of the micro-cellular polymer layer before the hot pressing is performed falls within the range of 0.24 g/cm³ to 0.48 g/cm³.

19. A flow adjusting mechanism as defined in claim 9 wherein a density of the micro-cellular polymer layer before the hot pressing is performed falls within the range of 0.24 g/cm³ to 0.48 g/cm³.

20. A flow adjusting mechanism as defined in claim 10 wherein a density of the micro-cellular polymer layer before the hot pressing is performed falls within the range of 0.24 g/cm³ to 0.48 g/cm³.

21. A flow adjusting mechanism as defined in claim 3 wherein the ratio of the hot-pressed layer thickness of the first micro-cellular polymer layer of the filter: the hot-pressed layer thickness of the artificial leather layer of the filter: the hot-pressed layer thickness of the second micro-cellular polymer layer of the filter, which ratio is obtained after the filter has been incorporated into the flow adjusting mechanism and has been mechanically compressed with in the flow adjusting mechanism, is approximately 1.5:1:1.5.

22. A flow adjusting mechanism as defined in claim 4 wherein the ratio of the hot-pressed layer thickness of the first micro-cellular polymer layer of the filter: the hot-pressed layer thickness of the artificial leather layer of the filter: the hot-pressed layer thickness of the second micro-cellular polymer layer of the filter, which ratio is obtained after the filter has been incorporated into the flow adjusting mechanism and has been mechanically compressed within the flow adjusting mechanism, is approximately 1.5:1:1.5.

23. A flow adjusting mechanism as defined in claim 5 wherein the ratio of the hot-pressed layer thickness of the first micro-cellular polymer layer of the filter: the hot-pressed layer thickness of the artificial leather layer of the filter: the hot-pressed layer thickness of the second micro-cellular polymer layer of the filter, which ratio is obtained after the filter has been incorporated into the flow adjusting mechanism and has been mechanically compressed within the flow adjusting mechanism, is approximately 1.5:1:1.5.

24. A flow adjusting mechanism as defined in claim 8 wherein the ratio of the hot-pressed layer thickness of the first micro-cellular polymer layer of the filter: the hot-pressed layer thickness of the artificial leather layer of the filter: the hot-pressed layer thickness of the second micro-cellular polymer layer of the filter, which ratio is obtained after the filter has been incorporated into the flow adjusting mechanism and has been mechanically compressed within the flow adjusting mechanism, is approximately 1.5:1:1.5.

25. A flow adjusting mechanism as defined in claim 9 wherein the ratio of the hot-pressed layer thickness of the first micro-cellular polymer layer of the filter: the hot-pressed layer thickness of the artificial leather layer of the filter: the hot-pressed layer thickness of the second micro-cellular polymer layer of the filter, which ratio is obtained after the filter has been incorporated into the flow adjusting mechanism and has been mechanically compressed within the flow adjusting mechanism, is approximately 1.5:1:1.5.

26. A flow adjusting mechanism as defined in claim 10 wherein the ratio of the hot-pressed layer thickness of the first micro-cellular polymer layer of the filter: the hot-pressed layer thickness of the artificial leather layer of the filter: the hot-pressed layer thickness of the second micro-cellular polymer layer of the filter, which ratio is obtained after the filter has been incorporated into the flow adjusting mechanism and has been mechanically compressed within the flow adjusting mechanism, is approximately 1.5:1:1.5.

27. A flow adjusting mechanism as defined in claim 13 wherein the ratio of the hot-pressed layer thickness of the first micro-cellular polymer layer of the filter: the hot-pressed layer thickness of the artificial leather layer of the filter: the hot-pressed layer thickness of the second micro-cellular polymer layer of the filter, which ratio is obtained after the filter has been incorporated into the flow adjusting mechanism and has been mechanically compressed within the flow adjusting mechanism, is approximately 1.5:1:1.5.

28. A flow adjusting mechanism as defined in claim 14 wherein the ratio of the hot-pressed layer thickness of the first micro-cellular polymer layer of the filter: the hot-pressed layer thickness of the artificial leather layer of the filter: the hot-pressed layer thickness of the second micro-cellular polymer layer of the filter, which ratio is obtained after the filter has been incorporated into the flow adjusting mechanism and has been mechanically compressed within the flow adjusting mechanism, is approximately 1.5:1:1.5.

29. A flow adjusting mechanism as defined in claim 15 wherein the ratio of the hot-pressed layer thickness of the first micro-cellular polymer layer of the filter: the hot-pressed layer thickness of the artificial leather layer of the filter: the hot-pressed layer thickness of the second micro-cellular polymer layer of the filter, which ratio is obtained after the filter has been incorporated into the flow adjusting mechanism and has been mechanically compressed within the flow adjusting mechanism, is approximately 1.5:1:1.5.

30. A flow adjusting mechanism as defined in claim 16 wherein the ratio of the hot-pressed layer thickness of the first micro-cellular polymer layer of the filter: the hot-pressed layer thickness of the artificial leather layer of the filter: the hot-pressed layer thickness of the second micro-cellular polymer layer of the filter, which ratio is obtained after the filter has been incorporated into the flow adjusting mechanism and has been mechanically compressed within the flow adjusting mechanism, is approximately 1.5:1:1.5.

31. A flow adjusting mechanism as defined in claim 17 wherein the ratio of the hot-pressed layer thickness of the first micro-cellular polymer layer of the filter: the hot-pressed layer thickness of the artificial leather layer of the filter: the hot-pressed layer thickness of the second micro-cellular polymer layer of the filter, which ratio is obtained after the filter has been incorporated into the flow adjusting mechanism and has been mechanically compressed within the flow adjusting mechanism, is approximately 1.5:1:1.5.

32. A flow adjusting mechanism as defined in claim 18 wherein the ratio of the hot-pressed layer thickness of the first micro-cellular polymer layer of the filter: the hot-pressed layer thickness of the artificial leather layer of the filter: the hot-pressed layer thickness of the second micro-cellular polymer layer of the filter, which ratio is obtained after the filter has been incorporated into the flow adjusting mechanism and has been mechanically compressed within the flow adjusting mechanism, is approximately 1.5:1:1.5.

33. A flow adjusting mechanism as defined in claim 19 wherein the ratio of the hot-pressed layer thickness of the first micro-cellular polymer layer of the filter: the hot-pressed layer thickness of the artificial leather layer of the filter: the hot-pressed layer thickness of the second micro-cellular polymer layer of the filter, which ratio is obtained after the filter has been incorporated into the flow adjusting mechanism and has been mechanically compressed within the flow adjusting mechanism, is approximately 1.5:1:1.5.

34. A flow adjusting mechanism as defined in claim 20 wherein the ratio of the hot-pressed layer thickness of the first micro-cellular polymer layer of the filter: the hot-pressed layer thickness of the artificial leather layer of the filter: the hot-pressed layer thickness of the second micro-cellular polymer layer of the filter, which ratio is obtained after the filter has been incorporated into the flow adjusting mechanism and has been mechanically compressed within the flow adjusting mechanism, is approximately 1.5:1:1.5.
